(19) United States
(12) Patent Application Publication
(10) Pub. No.: US 2023/0007511 A1
(43) Pub. Date: Jan. 5, 2023

(54) WIRELESS NETWORK DEVICE AND INFORMATION COLLECTION METHOD FOR WIRELESS NETWORK DEVICE

(71) Applicant: NEC Corporation, Tokyo (JP)

(72) Inventor: Hirokazu OZAWA, Tokyo (JP)

(73) Assignee: NEC Corporation, Tokyo (JP)

(21) Appl. No.: 17/847,524

(22) Filed: Jun. 23, 2022

(30) Foreign Application Priority Data
Jul. 2, 2021 (JP) 2021-110688

(51) Int. Cl. H04W 24/04

(52) U.S. Cl. CPC H04W 24/04; H04L 41/04

(57) ABSTRACT

Provided are a wireless network device and an information collection method for the wireless network device, which are suitable for collecting large-capacity device information. A wireless network device is a wireless network device to be connected to a master node, the wireless network device including: a storage device that stores information on the subject device; and a control unit that detects that a storage capacity in the storage device has reached a certain capacity and performs control in such a way that information stored in the storage device is transmitted to a path to the master node.

This application is based upon and claims the benefit of priority from Japanese Patent Application No. 2021-110688, filed on Jul. 2, 2021, the disclosure of which is incorporated herein in its entirety by reference.

### TECHNICAL FIELD

The present invention relates to a wireless network device and an information collection method for the wireless network device, and particularly relates to collection of communication device information such as statistical information.

### BACKGROUND ART

A network in which a network management system (NMS) monitors a plurality of wireless access network devices (NEs) as an example of a plurality of wireless network devices is known. The NMS periodically collects communication device information such as statistical information from each NE.

Japanese Patent Application Laid-open No. 2019-509693 (JP2019-509693A) relates to a wireless node network, and proposes a wireless node network including a server, a master node, an ID node A, and an ID node B. JP2019-509693A proposes that when the ID node A detects an advertising message from the ID node B, indicating that the ID node B has data (sensor data) for upload, the ID node A operates in a query (scan) mode of listening for the ID node B, and records a scan result in a log. Further, JP2019-509693A proposes that when the ID node A is next connected to the master node, the ID node A uploads the acquired scan log information to the server.

However, the above-described collection of the communication device information has issues (1) to (4) exemplified below.

(1) Increase in Statistical Information Collection Time and Network Bandwidth Usage

Since the NMS that manages the NEs collects the statistical information from each NE, the collection time increases as the number of NEs increases. In addition, when collection destination NEs are connected in multiple stages, the number of hops to a collection target NE increases. Since the NMS is connected point-to-point for each NE in the network, a larger amount of bandwidth in the network are consumed as the number of hops to the collection target NE increases.

(2) Transfer of Configuration Information

At the time of device replacement, configuration data to be set disappears, and periodic collection from the NMS is required.

(3) Collection of Failure Analysis Information

When a problem event occurs in the NE and data for failure analysis is collected, if it is difficult to access the target NE due to loss of volatile memory information due to occurrence of device restart or a communication path failure, the NMS cannot collect data for failure analysis.

(4) Collection of Detailed Information

Detailed information having a large amount of information, such as reception sensitivity, temperature information, and flow information, is not included in the data to be acquired due to limitation of the storage capacity of the NE or collection time limitation of the NMS.

As described above, as the number of NEs to be monitored increases, the amount of device information to be collected increases, and there is a concern about an increase in collection time and an increase in load on the user network. In addition, when the collection destination NEs are connected in multiple stages via another NE, the number of hops connected to the collection target NE increases, and a large amount of wireless bandwidth is used in proportion to the number of passing NEs. In addition, when a failure occurs in an NE, a log including debugging information to be analyzed by a device development department is collected, but depending on the failure, the central processing unit (CPU) may be reset, and the data stored in the volatile memory may be lost.

In the technique in which the ID node A pulls up data from the ID node B by the query (scan) mode in which the ID node A listens for the ID node B as disclosed in JP2019-509693A, there is an issue that a large amount of bandwidth in the network is consumed and data cannot be collected when a problem event occurs in the ID node.

An object of the present invention is to provide a wireless network device and an information collection method for the wireless network device, which are suitable for collecting large-capacity device information.

### SUMMARY

In order to achieve the above object, a wireless network device according to the present invention is a wireless network device to be connected to a master node, the wireless network device including:

a storage device that stores information on the subject device; and a control unit that detects that a storage capacity in the storage device has reached a certain capacity and performs control in such a way that information stored in the storage device is transmitted to a path to the master node.

A network system according to the present invention includes:

the wireless network device, a master node, and a network management system that manages the wireless network device and the master node.

An information collection method for a wireless network device according to the present invention is an information collection method for a wireless network device to be connected to a master node, wherein

the wireless network device stores information on the subject device in a storage device, detects that a storage capacity in the storage device has reached a certain capacity, and transmits the information stored in the storage device to a path to the master node.

According to the present invention, a wireless network device and an information collection method for the wireless network device, which are suitable for collecting large-capacity device information, can be implemented.

### BRIEF DESCRIPTION OF THE DRAWINGS

Exemplary features and advantages of the present invention will become apparent from the following detailed description when taken with the accompanying drawings in which:

FIG. 1 is a block diagram for explaining a wireless network device and an information collection method for the wireless network device according to an example embodiment of a superordinate concept of the present invention;

FIG. 2 is a block diagram for explaining a wireless network device, an information collection method for the wireless network device, and a wireless network system using the wireless network device according to a first example embodiment of the present invention;

FIG. 3 is a block diagram for explaining an example of a configuration of a wireless access network device according to an example embodiment;

FIG. 4 is a sequence chart for explaining a procedure for determining a master node in the wireless network system according to the first example embodiment;

FIG. 5 is a sequence chart for explaining a procedure of data transmission to a master node in the wireless network system according to the first example embodiment;

FIG. 6 is a sequence chart for explaining a procedure of data transmission in a case where a failure occurs on a transmission path to a master node in the wireless network system according to the first example embodiment;

FIG. 7 is a sequence chart for explaining a procedure of data transmission when a failure that has occurred on a transmission path to a master node is recovered in the wireless network system according to the first example embodiment; and

FIG. 8 is a block diagram for explaining a wireless network device, an information collection method for the wireless network device, and a wireless network system using the wireless network device according to a second example embodiment of the present invention.

### EXAMPLE EMBODIMENT

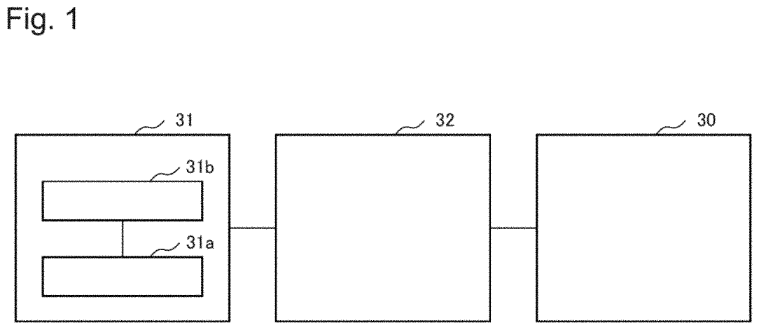

Before specific example embodiments of the present invention are described, a wireless network device and an information collection method for the wireless network device according to the example embodiments of the superordinate concept of the present invention are described. FIG. 1 is a block diagram for explaining a wireless network device and an information collection method for the wireless network device according to an example embodiment of a superordinate concept of the present invention.

The wireless network system of FIG. 1 includes a plurality of wireless network devices, and a master node 30 is set among the plurality of wireless network devices. The wireless network system in FIG. 1 includes, for example, the master node 30 and a plurality of wireless network devices 31 and 32. Although the wireless network device 31 is illustrated in more detail in FIG. 1, the wireless network device 31 includes a storage device 31a that stores device information and the like, and a control unit 31b. The control unit 31b detects that the storage capacity in the storage device 31a has reached a certain capacity, and performs control in such a way that the information stored in the storage device 31a is transmitted to a path to the master node 30. The control unit 31b will be composed by a processor represented by a central processing unit (CPU) or a micro-processing unit (MPU).

The wireless network device of the present example embodiment is an example of a wireless access network device (NE). For example, in the wireless network device 31, the control unit 31b monitors the storage capacity of the storage device 31a of the subject device. When the storage capacity of the storage device 31a reaches a certain capacity (threshold), information such as the device information stored in the storage device 31a is transmitted to the wireless network device existing on the path to the master node 30. Here, the certain capacity (threshold) is set to a capacity smaller than the maximum value of the storage capacity of the storage device 31a, and measures are taken in such a way that information such as stored device information is transmitted at a timing before the storage device 31a becomes full.

According to the wireless network device and the information collection method for the wireless network device of the present invention, the wireless network device autonomously monitors a storage capacity of a storage device of the wireless network device, and when the storage capacity of the storage device of the wireless network device reaches a certain capacity (threshold), the wireless network device autonomously transmits information such as device information stored in the storage device 31a to a wireless network device existing on a path to the master node 30. As a result, for example, the collection time can be shortened and the usage of the network bandwidth can be reduced as compared with the case where the NMS that manages the wireless network devices individually collects the statistical information from each wireless network device.

In addition, for example, it is not necessary for the NMS that manages the wireless network devices to periodically collect statistical information from each wireless network device. Thus, it is possible to collect the stored data in the storage device of each wireless network device even at the time of replacing devices of the wireless network system, and it is possible to prevent failure in collection of the stored data and loss of the stored data. Hereinafter, a more specific example embodiment will be described in detail with reference to the drawings.

### First Example Embodiment

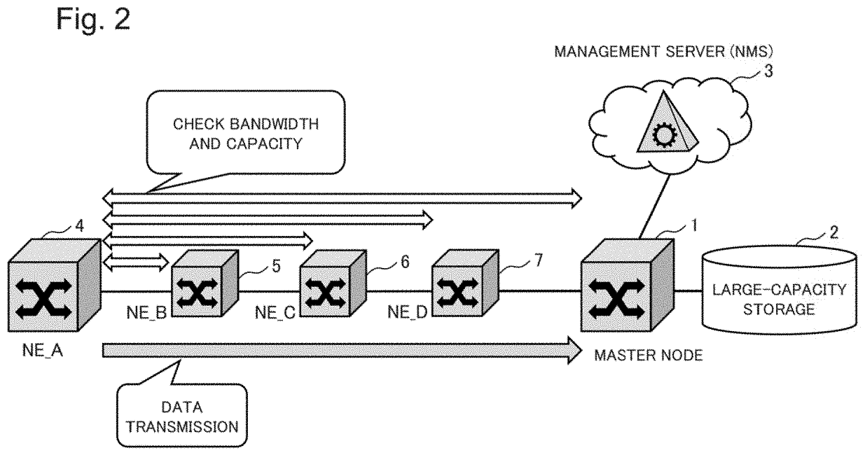

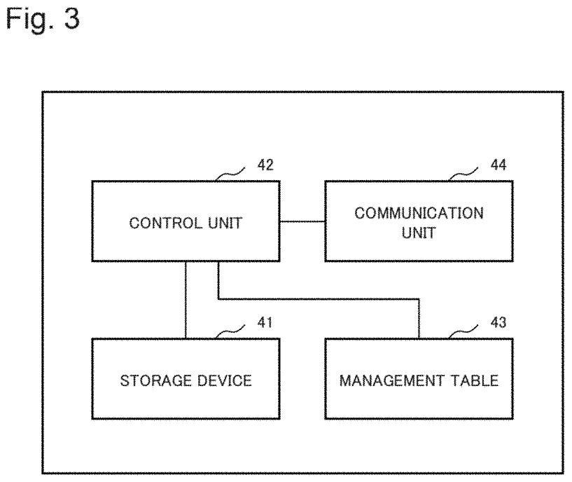

A wireless network device and an information collection method for the wireless network device according to a first example embodiment of the present invention will be described. FIG. 2 is a block diagram for explaining a wireless network device, an information collection method for the wireless network device, and a wireless network system using the wireless network device according to the first example embodiment of the present invention. FIG. 3 is a block diagram for explaining an example of a configuration of a wireless access network device according to an example embodiment.

(Configuration of Example Embodiment)

The wireless network system of FIG. 2 includes a master node 1, a large-capacity storage 2, a management server (NMS) 3, and wireless access network devices (NEs) as an example of a plurality of wireless network devices. The plurality of wireless access network devices (NE) includes NE4 (NE_A), NE5 (NE_B), NE6 (NE_C), NE7 (NE_D), and the like, and the master node 1 is set among the plurality of NEs.

The management server (NMS) 3 manages a plurality of wireless access network devices (NEs) in the wireless network system, and collects information such as device information stored in each NE. The master node 1 is connected to the large-capacity storage 2 and the management server (NMS) 3. The large-capacity storage 2 stores information such as device information stored in the plurality of wireless access network devices (NE) in the wireless network system, and has a large storage capacity as compared with the storage capacity of the storage device in the wireless access network device (NE).

In the wireless network system of FIG. 2, NE4 (NE_A) is connected to the master node 1 via NE5 (NE_B), NE6 (NE_C), and NE7 (NE_D).

Each wireless access network device (NE) has, for example, a configuration illustrated in FIG. 3. That is, each wireless access network device (NE) includes a storage device 41, a control unit 42, a management table 43, and a communication unit 44. The storage device 41 stores information such as device information of the subject device. The control unit 42 controls each element in the wireless access network device (NE) and monitors a storage capacity of the storage device 41. When the storage capacity of the storage device 41 reaches a certain capacity (threshold), the control unit 42 checks whether or not information such as the device information stored in the storage device 41 can be transmitted to the wireless access network device (NE) existing on the path to the master node 1, for example, the adjacent NE 5 (NE_B). The management table 43 holds setting information on a subnetwork managed by the management server (NMS) 3. The communication unit 44 communicates with the master node 1 and a wireless access network device (NE) existing in the path to the master node 1, and performs transmission for checking bandwidth and capacity, reception of a response, and the like.

(Summary of Information Collection Procedure According to the Present Example Embodiment)

The control procedure of information collection according to the present example embodiment can be summarized as the following procedure 1 to procedure 5.

(Procedure 1) A master node is determined among the NEs in the same subnetwork. The vacant capacity of the storage device and the distance to the NMS are exchanged between the respective NEs, and the NE having the maximum capacity and the shortest distance to the NMS is determined as the master node.

(Procedure 2) Operation service is started in each NE, and collection of statistical information is started. After a lapse of a certain time, the storage capacity of a certain NE reaches a threshold.

(Procedure 3) The NE that has reached the threshold checks the state of a wireless bandwidth and the vacant capacity with respect to the adjacent NE close to the master node. The NE repeatedly performs arrival confirmation on each NE existing up to the master node.

(Procedure 4) After completion of the arrival confirmation to the master node, data is transmitted from the NE to the master node.

(Procedure 5) The NE deletes the data whose transmission has been completed from the storage device in the NE.

Hereinafter, a procedure of information collection will be described in more detail with reference to a sequence chart.

(Sequence for Determining Master Node)

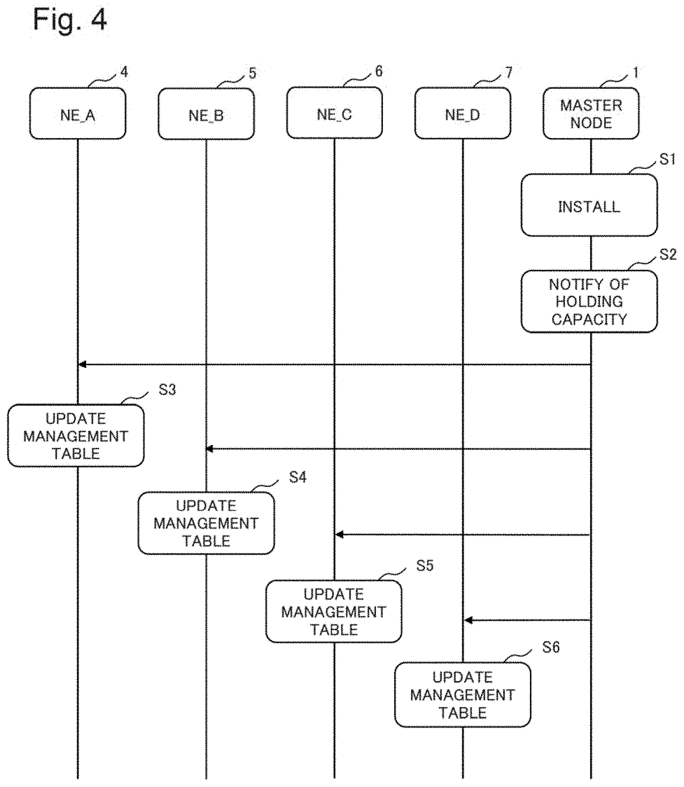

First, a sequence for determining a master node from a plurality of wireless access network devices (NEs) in a wireless network system will be described. FIG. 4 is a sequence chart for explaining a procedure for determining a master node in the wireless network system according to the first example embodiment.

Here, an example of a case where the master node 1 is installed adjacent to NE7 (NE_D) in a state where the connection from NE4 (NE_A) to NE7 (NE_D) is already established on the network as illustrated in FIG. 2 will be described. When the master node 1 is newly installed (S1), the newly installed master node 1 notifies each of the NEs 4, 5, 6, and 7 of the distance to the NMS and the holding capacity of the subject device (S2). Each NE having received the information updates the management table in the subject device, and determines the master node 1 having the maximum capacity in the network as a master node. That is, in response to the notification of S2, NE4 (NE_A) updates the management table in the subject device (S3), NE5 (NE_B) updates the management table in the subject device (S4), NE6 (NE_C) updates the management table in the subject device (S5), and NE7 (NE_D) updates the management table in the subject device (S6).

(Sequence of Collecting Information Such as Device Information)

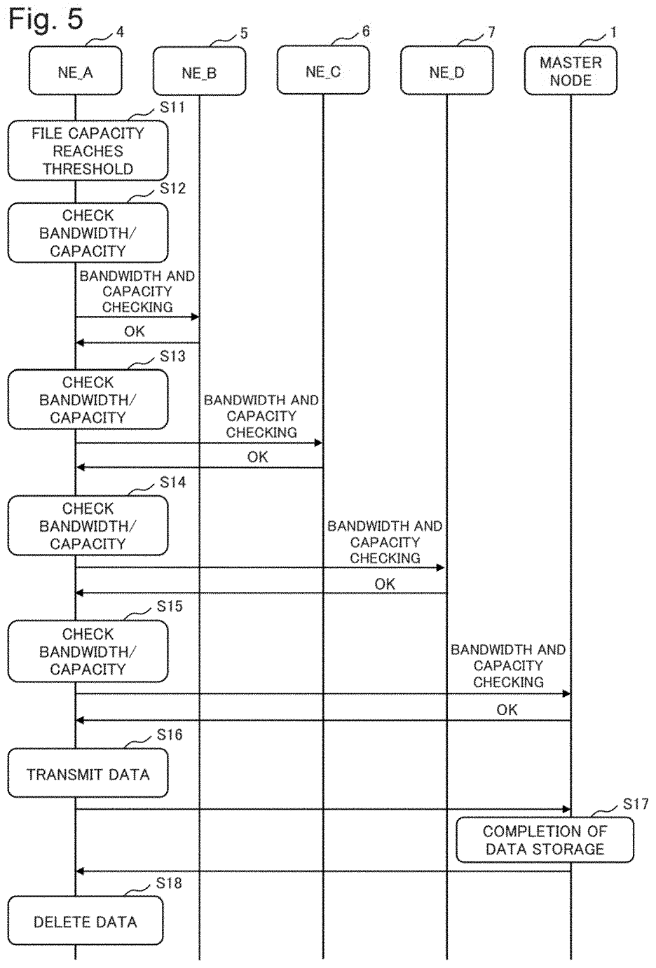

Next, a sequence of collecting information such as device information by the wireless network system of the present example embodiment will be described. FIG. 5 is a sequence chart for explaining a procedure of data transmission to a master node in the wireless network system according to the first example embodiment.

FIG. 5 illustrates an example of a case where the storage capacity of the storage device 41 of the NE 4 (NE_A) reaches a certain capacity (threshold) and data is transmitted to the master node 1. When the storage capacity of the storage device 41 reaches the threshold (S11), the control unit 42 of the NE4 (NE_A) checks the bandwidth/capacity of the adjacent NE5 (NE_B) via the communication unit 44 (S12). The checking of the bandwidth/capacity is checking of the wireless bandwidth of the path from NE4 (NE_A) to NE5 (NE_B) and checking of the storage capacity of the storage device of NE5 (NE_B).

In response to the checking of the bandwidth/capacity, the control unit of NE5 (NE_B) transmits a response to NE4 (NE_A). Here, it is assumed that an OK response has been transmitted.

Subsequently, the control unit 42 of the NE 4 (NE_A) checks the bandwidth/capacity of the NE 6 (NE_C) via the communication unit 44 (S13). The checking of the bandwidth/capacity is checking of the wireless bandwidth of the path from NE4 (NE_A) to NE6 (NE_C) and checking of the storage capacity of the storage device of NE6 (NE_C).

In response to the checking of the bandwidth/capacity, the control unit of NE6 (NE_C) transmits a response to NE4 (NE_A). Here, it is assumed that an OK response has been transmitted.

Subsequently, the control unit 42 of the NE 4 (NE_A) checks the bandwidth/capacity of the NE 7 (NE_D) via the communication unit 44 (S14). The checking of the bandwidth/capacity is checking of the wireless bandwidth of the path from NE4 (NE_A) to NE7 (NE_D) and checking of the storage capacity of the storage device of NE7 (NE_D).

In response to the checking of the bandwidth/capacity, the control unit of NE7 (NE_D) transmits a response to NE4 (NE_A). Here, it is assumed that an OK response has been transmitted.

Subsequently, the control unit 42 of the NE 4 (NE_A) checks the bandwidth/capacity with respect to the master node 1 via the communication unit 44 (S15). The checking of the bandwidth/capacity is checking of the wireless bandwidth of the path from the NE 4 (NE_A) to the master node 1 and checking of the storage capacity of the large-capacity storage 2 connected to the master node 1.

In response to the checking of the bandwidth/capacity, the control unit of the master node 1 transmits a response to NE4 (NE_A). Here, it is assumed that an OK response has been transmitted.

As described above, the NE4 (NE_A) in which the storage capacity of the storage device 41 has reached a certain capacity (threshold) checks the bandwidth/capacity up to the master node 1. When it is confirmed that there is no problem on the path regarding the wireless bandwidth and the capacity of the path to the master node 1, data is transmitted from the NE 4 (NE_A) to the master node 1 (S16). After the data transmission is completed and the data storage in the master node 1 is completed (S17), a completion notification is transmitted from the master node 1 to the NE 4 (NE_A). Upon receiving this completion notification, the NE 4 (NE_A) deletes the data whose transmission has been completed from the storage device 41 of the subject device. In this way, the information such as the device information stored in the storage device 41 of the NE 4 (NE_A) is transmitted to the master node 1.

(Sequence when Failure Occurs on Transmission Path to Master Node)

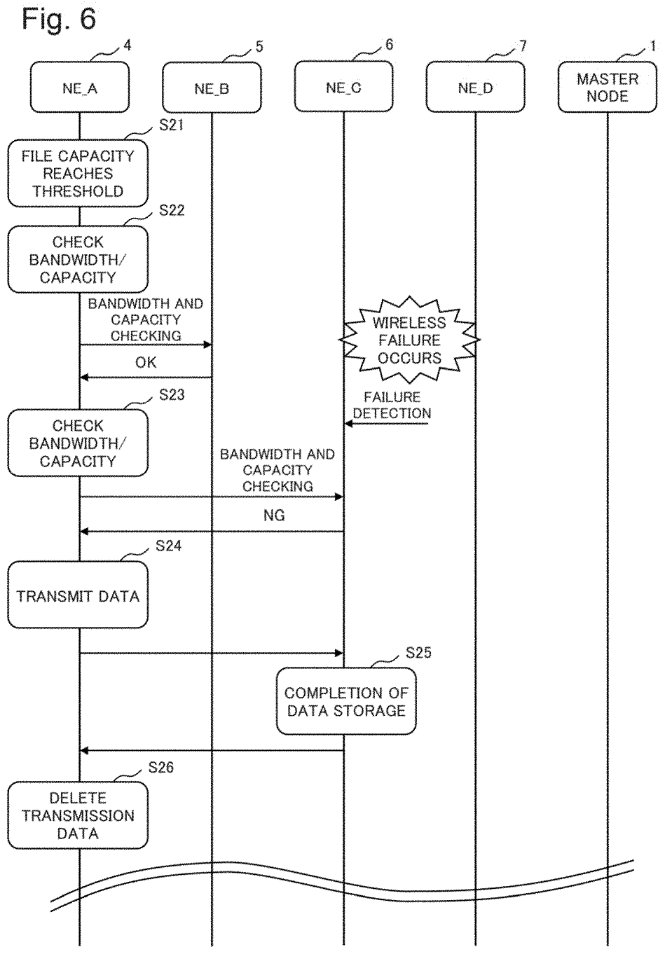

Next, data transmission assuming a case where a failure occurs on the transmission path to the master node will be described. FIG. 6 is a sequence chart for explaining a procedure of data transmission in a case where a failure occurs on a transmission path to a master node in the wireless network system according to the first example embodiment.

Similarly to the sequence chart of FIG. 5, FIG. 6 illustrates an example of a case where the storage capacity of the storage device 41 of the NE 4 (NE_A) reaches a certain capacity (threshold) and data is to be transmitted to the master node 1.

When the storage capacity of the storage device 41 reaches the threshold (S21), the control unit 42 of the NE4 (NE_A) checks the bandwidth/capacity of the adjacent NE5 (NE_B) via the communication unit 44 (S22). The checking of the bandwidth/capacity is checking of the wireless bandwidth of the path from NE4 (NE_A) to NE5 (NE_B) and checking of the storage capacity of the storage device of NE5 (NE_B).

In response to the checking of the bandwidth/capacity, the control unit of NE5 (NE_B) transmits a response to NE4 (NE_A). Here, it is assumed that an OK response has been transmitted.

Subsequently, the control unit 42 of the NE 4 (NE_A) checks the bandwidth/capacity of the NE 6 (NE_C) via the communication unit 44 (S23). The checking of the bandwidth/capacity is checking of the wireless bandwidth of the path from NE4 (NE_A) to NE6 (NE_C) and checking of the storage capacity of the storage device of NE6 (NE_C).

Here, it is assumed that a wireless failure occurs in a path from NE6 (NE_C) to the master node 1, for example, between NE6 (NE_C) and NE7 (NE_D), and the control unit of NE6 (NE_C) detects the failure.

The control unit of NE6 (NE_C) transmits a response to NE4 (NE_A) via the communication unit. The control unit of NE6 (NE_C) returns a bandwidth NG response to NE4 (NE_A) in response to the detected wireless failure.

Since it has been confirmed that there is no problem on the path with respect to the wireless bandwidth and the storage capacity to NE6 (NE_C), data is transmitted from NE4 (NE_A) to NE6 (NE_C) (S24). After completion of the data transmission, a completion notification indicating completion of the data storage in the storage device of the NE 6 (NE_C) (S25) is transmitted from the NE 6 (NE_C) to the NE 4 (NE_A). Upon receiving the completion notification, the NE 4 (NE_A) deletes the data whose transmission has been completed from the storage device 41 of the NE 4 (S26). In this way, the information such as the device information stored in the storage device 41 of the NE 4 (NE_A) is transmitted to the NE 6 (NE_C).

(Sequence when Failure Occurring on Transmission Path is Recovered)

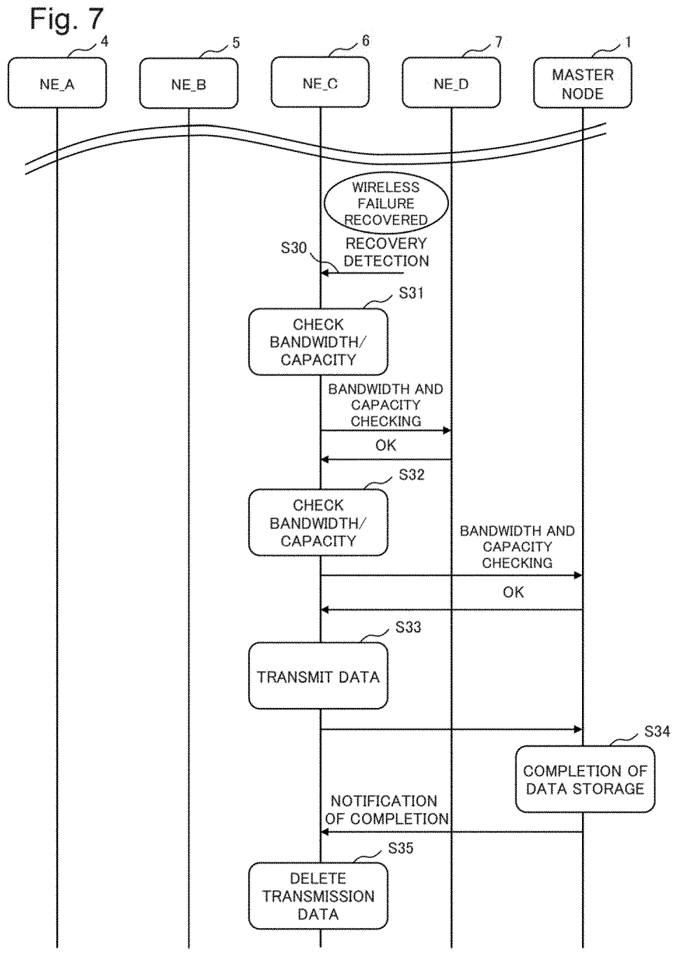

Next, data transmission on the assumption that a failure occurring on the transmission path to the master node is recovered will be described. FIG. 7 is a sequence chart for explaining a procedure of data transmission in a case where a failure that has occurred on a transmission path to a master node in the wireless network system according to the first example embodiment is recovered.

As a continuation of the sequence of FIG. 6, when the wireless failure occurring in the path between NE6 (NE_C) and NE7 (NE_D) is recovered and the control unit of NE6 (NE_C) detects the recovery (S30), the control unit of NE6 (NE_C) checks the bandwidth/capacity with respect to NE7 (NE_D) (S31). The checking of the bandwidth/capacity is checking of the wireless bandwidth of the path from NE6 (NE_C) to NE7 (NE_D) and checking of the storage capacity of the storage device of NE7 (NE_D).

In response to the checking of the bandwidth/capacity, the control unit of NE7 (NE_D) transmits a response to NE6 (NE_C). Here, it is assumed that an OK response has been transmitted.

Subsequently, the control unit of NE 6 (NE_C) checks the bandwidth/capacity with respect to the master node 1 (S32). The checking of the bandwidth/capacity is checking of the wireless bandwidth of the path from the NE 6 (NE_C) to the master node 1 and checking of the storage capacity of the large-capacity storage 2 connected to the master node 1.

In response to the checking of the bandwidth/capacity, the control unit of the master node 1 transmits a response to NE6 (NE_C). Here, it is assumed that an OK response has been transmitted.

In this way, since it is found that there is no problem on the transmission path to the master node 1, the NE 6 (NE_C) transmits the data from the NE 6 (NE_C) to the master node 1 (S33). After completion of the data transmission, a completion notification indicating completion of data storage in the large-capacity storage 2 connected to the master node 1 (S34) is transmitted from the master node 1 to the NE 6 (NE_C). Upon receiving this completion notification, the NE6 (NE_C) deletes the data whose transmission has been completed from the storage device of the NE6 itself. In this way, the information such as the device information stored in the storage device of the NE 6 (NE_C) is transmitted to the master node 1.

As described above, even when a failure occurs on the transmission path to the master node 1, each NE can transmit information such as device information to the storage device of the NE having no problem on the transmission path. In response to the completion of the data storage in the storage device of the NE having no problem on the transmission path, the NE of the transmission source can delete the data from the subject device to create a vacant capacity of the storage device, and can newly store information such as device information.

In addition, recovery of a failure occurring on the transmission path to the master node 1 can be detected, and information such as device information stored in the storage device of the NE on the transmission path to the master node 1 can be transmitted to the master node 1 after checking the bandwidth/capacity. In response to the completion of the data storage from the master node 1, the NE of the transmission source can delete the data from the subject device and create a vacant capacity of the storage device.

(Description of Advantageous Effect)

The wireless network device and the information collection method for the wireless network device according to the present example embodiment have a mechanism of monitoring a capacity of device information stored in the wireless access network device (NE) and autonomously transmitting the device information to a master node having a large-capacity storage when the capacity reaches a certain capacity. In addition, a mechanism is provided in which an abnormality such as a failure of a transmission path is confirmed by checking a state of a wireless bandwidth on a path to a master node, and when there is a wireless access network device (NE) in which a communication failure has occurred on the path, device information is transmitted to the wireless access network device (NE) in which the path is normal. Then, after the failure recovery, the device information is transmitted from the wireless access network device (NE) whose transmission path has been recovered to the master node.

The management server (NMS) 3 can collect device information of all wireless access network devices (NEs) in the network by accessing the master node 1 only. By applying this function, it is possible to realize periodic collection of information for failure analysis (debug log) at the time of device failure and device configuration information periodically, and collection of large-capacity device information such as temperature information observed in real time.

According to the wireless network device and the information collection method for the wireless network device of the present example embodiment, the following advantageous effects are obtained.

A first advantageous effect is that information such as device information is autonomously transmitted from the wireless access network device (NE) to the master node 1, and the information such as the device information of each wireless access network device (NE) is stored in the large-capacity storage 2 connected to the master node 1. As a result, the management server (NMS) 3 can collect information such as device information of the wireless access network device (NE) in the wireless network system of FIG. 2 by accessing the master node 1 only.

As described above, when each NE transmits information such as the device information to the master node 1 close to the management server (NMS) 3 among the plurality of wireless access network devices (NE), the time required for the management server (NMS) 3 to collect data of the device information can be reduced, and the management server (NMS) 3 can efficiently collect the information such as the device information. By adopting the above-described information collection sequence, the usage of the network bandwidth can be reduced as compared with the information collection in the background art.

A second advantageous effect is that the configuration information can be handed over at the time of device replacement. That is, it is possible to make it unnecessary to periodically collect information from the management server (NMS) 3 to each wireless access network device (NE). This is because each wireless access network device (NE) autonomously checks the bandwidth/capacity on the transmission path to the master node 1 and then transmits information such as device information to the master node 1 or the wireless access network device (NE) having no problem.

A third advantageous effect is that it becomes possible to also collect information for failure analysis. This is because each wireless access network device (NE) autonomously checks the bandwidth/capacity on the transmission path to the master node 1 and then transmits information such as device information to the master node 1 or the wireless access network device (NE) having no problem.

This is because, before the problem event occurs in the wireless access network device (NE), each wireless access network device (NE) autonomously checks the bandwidth/capacity on the transmission path to the master node 1, and then transmits information such as device information to the master node 1 or the wireless access network device (NE) having no problem. Before the problem event occurs in the wireless access network device (NE), data autonomously transmitted to the master node 1 or the wireless access network device (NE) on the transmission path to the master node 1 can be utilized as data for failure analysis.

A fourth advantageous effect is that it becomes possible to collect detailed information. This is because the memory capacity mounted on the device can be saved, and the management server (NMS) 3 can collect a larger number of pieces of detailed data such as physical information such as reception sensitivity and temperature information measured by the wireless access network device (NE), and flow information on the wireless access network device (NE).

In general, detailed information having a large amount of information, such as reception sensitivity, temperature information, and flow information, is not included in data to be acquired because of a limitation of a storage capacity of the NE or a limitation of the collection time of the NMS. According to the wireless network device and the information collection method for the wireless network device of the present example embodiment, after each wireless access network device (NE) autonomously checks the bandwidth/capacity on the transmission path to the master node 1, information such as device information is transmitted to the master node 1 or the wireless access network device (NE) having no problem, and in response to the completion of data storage, the NE as the transmission source can delete data from the subject device to create a free space in the storage device. With this sequence, the memory capacity mounted on the device can be saved, and detailed information having a large amount of information such as reception sensitivity, temperature information, and flow information, which is information other than the device information, can also be transmitted, and the management server (NMS) 3 can collect the information.

### Second Example Embodiment

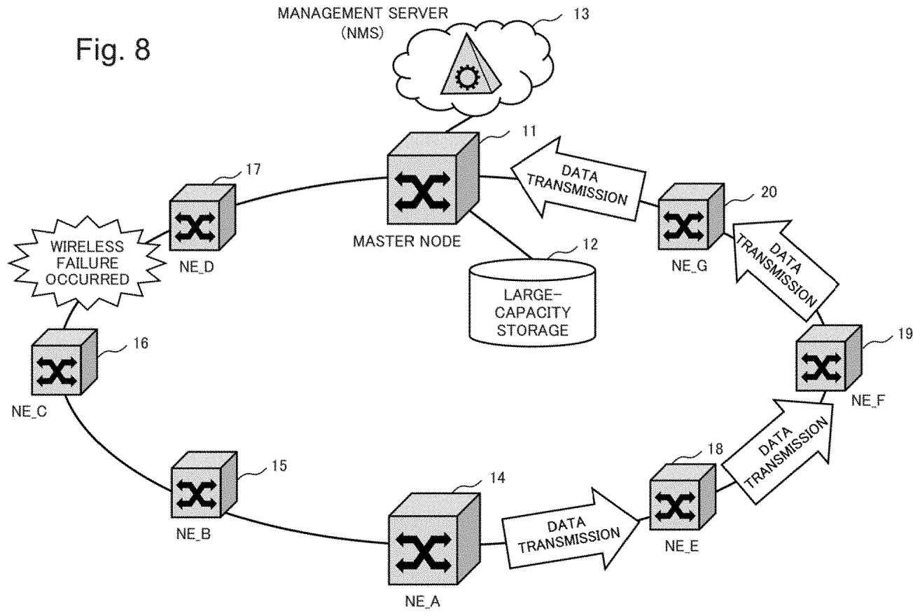

A wireless network device and an information collection method for the wireless network device according to a second example embodiment of the present invention will be described. FIG. 8 is a block diagram for explaining a wireless network device, an information collection method for the wireless network device, and a wireless network system using the wireless network device according to a second example embodiment of the present invention. Detailed description of configurations and operations similar to those of the first example embodiment will be omitted.

(Configuration of Example Embodiment)

The wireless network system of FIG. 8 includes a master node 11, a large-capacity storage 12, a management server (NMS) 13, and wireless access network devices (NEs) as an example of a plurality of wireless network devices. The plurality of wireless access network devices (NE) includes NE 14 (NE_A), NE 15 (NE_B), NE 16 (NE_C), NE 17 (NE_D), NE 18 (NE_E), NE 19 (NE_F), NE 20 (NE_G), and the like, and the master node 11 is set among the plurality of NEs.

The management server (NMS) 13 manages a plurality of wireless access network devices (NEs) in the wireless network system, and collects information such as device information stored in each NE. The master node 11 is connected to the large-capacity storage 12 and the management server (NMS) 13. The large-capacity storage 12 stores information such as device information stored in a plurality of wireless access network devices (NEs) in the wireless network system.

In the wireless network system of FIG. 8, NE 14 (NE_A) is connected to the master node 11 via NE 15 (NE_B), NE 16 (NE_C), and NE 17 (NE_D) in a clockwise direction, and is connected to the master node 11 via NE 18 (NE_E), NE 19 (NE_F), and NE 20 (NE_G) in a counterclockwise direction. As described above, in the wireless network system of FIG. 8, the entire subnetwork managed by the management server (NMS) 13 has a ring network configuration.

Also in the present example embodiment, each NE includes a storage device 41, a control unit 42, a management table 43, and a communication unit 44 as illustrated in FIG. 3, for example. The storage device 41 stores information such as device information of the subject device. The control unit 42 controls each element in the wireless access network device (NE) and monitors a storage capacity of the storage device 41. When the storage capacity of the storage device 41 reaches a certain capacity (threshold), the control unit 42 checks whether or not information such as the device information stored in the storage device 41 can be transmitted to the wireless access network device (NE) existing on the path to the master node 1, for example, the adjacent NE 15 (NE_B).

(Operation of Example Embodiment)

Next, the operation of the present example embodiment will be described. The wireless network system of FIG. 8 will be described on the assumption that the storage capacity of the storage device 41 of the NE 14 (NE_A) reaches a certain capacity (threshold) after a certain period of time from the start of the service. When the storage capacity of the storage device 41 reaches a certain capacity (threshold), the NE 14 (NE_A) checks the bandwidth/capacity of the adjacent NE 15 (NE_B). The checking of the bandwidth/capacity is checking of the wireless bandwidth of the path from NE 14 (NE_A) to NE 15 (NE_B) and checking of the storage capacity of the storage device of NE 15 (NE_B).

In response to the checking of the bandwidth/capacity, the control unit of NE 15 (NE_B) transmits a response to NE 14 (NE_A). Here, it is assumed that an OK response has been transmitted.

Subsequently, the control unit 42 of the NE 14 (NE_A) checks the bandwidth/capacity with respect to the NE 16 (NE_C) via the communication unit 44. The checking of the bandwidth/capacity is checking of the wireless bandwidth of the path from NE 14 (NE_A) to NE 16 (NE_C) and checking of the storage capacity of the storage device of NE 16 (NE_C).

Here, it is assumed that a wireless failure occurs in a path from the NE 16 (NE_C) to the master node 11, for example, between the NE 16 (NE_C) and the NE 17 (NE_D), and the control unit of the NE 16 (NE_C) detects the failure.

At this time, the control unit of NE 16 (NE_C) transmits a response to NE 14 (NE_A) via the communication unit. The control unit of NE 16 (NE_C) returns a bandwidth NG response to NE 14 (NE_A) in response to the detected wireless failure.

In the wireless network system of FIG. 8, since the entire subnetwork managed by the management server (NMS) 13 has a ring network configuration, the NE 14 (NE_A) can be connected to the master node 11 even from the NE 18 (NE_E) direction which is the counterclockwise direction. In consideration of this, the NE 14 (NE_A) checks the bandwidth/capacity with respect to the adjacent NE 18 (NE_E). The checking of the bandwidth/capacity is checking of the wireless bandwidth of the path from NE 14 (NE_A) to NE 18 (NE_E) and checking of the storage capacity of the storage device of NE 18 (NE_E).

In response to the checking of the bandwidth/capacity, the control unit of NE 18 (NE_E) transmits a response to NE 14 (NE_A). Here, it is assumed that an OK response has been transmitted.

Subsequently, the control unit 42 of the NE 14 (NE_A) checks the bandwidth/capacity with respect to the NE 19 (NE_F) via the communication unit 44. The checking of the bandwidth/capacity is checking of the wireless bandwidth of the path from NE 14 (NE_A) to NE 19 (NE_F) and checking of the storage capacity of the storage device of NE 19 (NE_F).

Similarly, the control unit 42 of the NE 14 (NE_A) checks the bandwidth/capacity for the NE 19 (NE_F), the NE 20 (NE_G), and the master node 11 via the communication unit 44. When it is confirmed that there is no problem on the path regarding the wireless bandwidth and the capacity of the path from the NE 14 (NE_A) to the master node 11 in the counterclockwise direction, data is transmitted to the master node 11 through the counterclockwise path from the NE 14 (NE_A). After the data transmission is completed and the data storage in the master node 11 is completed, a completion notification is transmitted from the master node 11 to the NE 14 (NE_A). NE 14 (NE_A) that has received the completion notification deletes the data whose transmission has been completed from storage device 41 of the subject device.

In this way, the information such as the device information stored in the storage device 41 of the NE 14 (NE_A) is transmitted to the master node 11. Even when a wireless failure occurs in a path from the NE 16 (NE_C) to the master node 11, that is, between the NE 16 (NE_C) and the NE 17 (NE_D) in FIG. 8, the NE 14 (NE_A) transmits data from the NE 14 (NE_A) to the master node 11 when it can be confirmed that there is no problem on the path regarding the wireless bandwidth and the capacity in the path to the other master node 11.

(Description of Advantageous Effect)

According to the wireless network device and the information collection method for the wireless network device of the present example embodiment, the first advantageous effect, the second advantageous effect, the third advantageous effect, and the fourth advantageous effect are obtained similarly to the first example embodiment.

The reason is that information such as device information is autonomously transmitted from the wireless access network device (NE) to the master node 11, and the information such as the device information of each wireless access network device (NE) is stored in the large-capacity storage 12 connected to the master node 11. This is because the management server (NMS) 13 can collect information such as device information of the wireless access network device (NE) in the wireless network system of FIG. 8 by accessing the master node 11 only.

In a case where there are two or more paths to the master node 11, an optimal path is selected. This optimal path is selected based on the distance and capacity of each wireless access network device (NE). When a communication failure occurs on the optimal path, the path is switched, and the device information is transmitted to the master node 11 from the path without the communication failure.

According to the wireless network device and the information collection method for the wireless network device of the present example embodiment, the wireless access network device (NE) in which the storage capacity of the storage device 41 has reached a certain capacity (threshold) can transmit data to the master node 11 after confirming that there is no problem on the path regarding the wireless bandwidth and the capacity in the path to the master node 11. Even when a wireless failure occurs anywhere on the path from the wireless access network device (NE) to the master node 11, after it is confirmed that there is no problem on the path regarding other wireless bandwidths and capacities, data can be transmitted from the wireless access network device (NE) to the master node 11 through the path having no problem.

### Other Example Embodiments

Although the preferred example embodiments of the present invention have been described above, the present invention is not limited thereto. For example, in the above example embodiment, the information such as the device information stored in the storage device of the wireless access network device (NE) is transmitted with the fact that the storage capacity of the storage device has reached a certain capacity (threshold) as a trigger, but the present invention is not limited thereto. For example, the transmission condition of data transmission is not limited to a certain storage capacity threshold of the storage device, but a threshold of the storage capacity can be set for each schedule method of transmitting data on time or each data type to be acquired.

In the first example embodiment and the second example embodiment described above, it has been mainly described that the NE 4 (NE_A) or the NE 14 (NE_A) existing on the farthest path from the master node autonomously transmits information such as device information to the master node, and the information such as the device information of each wireless access network device (NE) is stored in the large-capacity storage connected to the master node. However, it is apparent that NE5 (NE_B), NE6 (NE_C), and NE_7 (NE_D) in FIG. 2, and NE 15 (NE_B), NE 16 (NE_C), NE 17 (NE_D), NE 18 (NE_E), NE 19 (NE_F), and NE 20 (NE_G) in FIG. 8 also operate autonomously.

In the second example embodiment, when a wireless failure occurs between the NE 16 (NE_C) and the NE 17 (NE_D) and the control unit of the NE 16 (NE_C) detects the failure, it is confirmed that there is no problem on the path regarding the wireless bandwidth and the capacity of the path from the NE 14 (NE_A) to the master node 11 in the counterclockwise direction, and the data is transmitted from the NE 14 (NE_A) to the master node 11 on the counterclockwise path. However, the present invention is not limited thereto. It is also conceivable to apply the sequence of the first example embodiment to the second example embodiment, store information such as the device information of the NE 14 (NE_A) in the storage device of the NE 16 (NE_C) having no problem on the path regarding the wireless bandwidth and capacity of the path from the NE 14 (NE_A) to the master node 11 in the clockwise direction, then confirm that the wireless failure has been recovered, and transmit the data to the master node 11 on the path to the master node 11 in the clockwise direction. Various modifications are possible within the scope of the invention described in the claims, and naturally, they are also included in the scope of the present invention.

The whole or part of the example embodiments disclosed above can be described as, but not limited to, the following supplementary notes.

(Supplementary Note 1) A wireless network device to be connected to a master node, the wireless network device including:

a storage device that stores information on the subject device; and a control unit that detects that a storage capacity in the storage device has reached a certain capacity and performs control in such a way that information stored in the storage device is transmitted to a path to the master node.

(Supplementary Note 2) The wireless network device according to Supplementary Note 1, wherein

after the wireless network device receives, from the master node, a notification of completion of storage of the information stored in the storage device into the master node or a storage connected to the master node, the wireless network device deletes the information on the subject device stored in the storage device.

(Supplementary Note 3) The wireless network device according to Supplementary Note 1, wherein

when one or more other wireless network devices are connected to the path to the master node,

the control unit detects a communication failure on the path to the master node, and transmits the information stored in the storage device to the other wireless network device confirmed to have no problem on the path to the path to the master node.

(Supplementary Note 4) The wireless network device according to Supplementary Note 3, wherein

after the wireless network device receives, from the other wireless network device confirmed to have no problem on the path, a notification of completion of storage of the information stored in the storage device into a storage device included in the other wireless network device, the wireless network device deletes the information on the subject device stored in the storage device.

(Supplementary Note 5) The wireless network device according to Supplementary Note 3 or 4, wherein

when recovery of the communication failure on the path to the master node is detected, the other wireless network device transmits the information stored in the storage device of the another wireless network device to the path to the master node.

(Supplementary Note 6) The wireless network device according to any one of Supplementary Notes 1 to 5, wherein

when there are two or more paths to the master node, the wireless network device selects a path based on a distance to the master node and a storage capacity of the other wireless network device existing in the path to the master node, and transmits the information stored in the storage device to the selected path to the master node.

(Supplementary Note 7) A network system including:

the wireless network device according to any one of Supplementary Notes 1 to 6; a master node; and a network management system that manages the wireless network device and the master node.

(Supplementary Note 8) The network system according to Supplementary Note 7, wherein

the network management system accesses the master node to collect information on the wireless network device stored in the master node or stored in a storage connected to the master node.

(Supplementary Note 9) An information collection method for a wireless network device to be connected to a master node, wherein

the wireless network device stores information on the subject device in a storage device, detects that a storage capacity in the storage device has reached a certain capacity, and transmits the information stored in the storage device to a path to the master node.

(Supplementary Note 10) The information collection method for the wireless network device according to Supplementary Note 9, wherein

after the wireless network device receives, from the master node, a notification of completion of storage of the information stored in the storage device into the master node or a storage connected to the master node, the wireless network device deletes the information on the subject device stored in the storage device.

(Supplementary Note 11) The information collection method for the wireless network device according to Supplementary Note 10, wherein

when one or more other wireless network devices are connected to the path to the master node,

the wireless network device detects a communication failure on the path to the master node, and transmits the information stored in the storage device to the other wireless network device confirmed to have no problem on the path to the path to the master node.

(Supplementary Note 12) The information collection method for the wireless network device according to Supplementary Note 11, wherein

after the wireless network device receives, from the other wireless network device confirmed to have no problem on the path, a notification of completion of storage of the information stored in the storage device into a storage device included in the other wireless network device, the wireless network device deletes the information on the subject device stored in the storage device.

(Supplementary Note 13) The information collection method for the wireless network device according to Supplementary Note 12, wherein

when recovery of the communication failure on the path to the master node is detected, the other wireless network device transmits the information stored in the storage device of the another wireless network device to the path to the master node.

(Supplementary Note 14) The information collection method for the wireless network device according to any one of Supplementary Notes 9 to 13, wherein

when there are two or more paths to the master node, the wireless network device selects a path based on a distance to the master node and a storage capacity of the other wireless network device existing in the path to the master node, and transmits the information stored in the storage device to the selected path to the master node.

(Supplementary Note 15) The information collection method for the wireless network device according to any one of Supplementary Notes 9 to 14, wherein

a network management system that manages the wireless network device and the master node

accesses the master node to collect information on the wireless network device stored in the master node or stored in a storage connected to the master node.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A wireless network device to be connected to a master node, the wireless network device comprising:
a storage device that stores information on the subject device; and
a control unit that detects that a storage capacity in the storage device has reached a certain capacity and performs control in such a way that information stored in the storage device is transmitted to a path to the master node.

2. The wireless network device according to claim 1, wherein
after the wireless network device receives, from the master node, a notification of completion of storage of the information stored in the storage device into the master node or a storage connected to the master node, the wireless network device deletes the information on the subject device stored in the storage device.

3. The wireless network device according to claim 1, wherein
when one or more other wireless network devices are connected to the path to the master node,
the control unit detects a communication failure on the path to the master node, and transmits the information stored in the storage device to the other wireless network device confirmed to have no problem on the path to the path to the master node.

4. The wireless network device according to claim 3, wherein
after the wireless network device receives, from the other wireless network device confirmed to have no problem on the path, a notification of completion of storage of the information stored in the storage device into a storage device included in the other wireless network device, the wireless network device deletes the information on the subject device stored in the storage device.

5. The wireless network device according to claim 3, wherein
when recovery of the communication failure on the path to the master node is detected, the other wireless network device transmits the information stored in the storage device of the another wireless network device to the path to the master node.

6. The wireless network device according to claim 1, wherein
when there are two or more paths to the master node, the wireless network device selects a path based on a distance to the master node and a storage capacity of the other wireless network device existing in the path to the master node, and transmits the information stored in the storage device to the selected path to the master node.

7. A network system comprising:
the wireless network device according to claim 1;
a master node; and
a network management system that manages the wireless network device and the master node.

8. The network system according to claim 7, wherein
the network management system accesses the master node to collect information on the wireless network device stored in the master node or stored in a storage connected to the master node.

9. An information collection method for a wireless network device to be connected to a master node, wherein
the wireless network device stores information on the subject device in a storage device, detects that a storage capacity in the storage device has reached a certain capacity, and transmits the information stored in the storage device to a path to the master node.

10. The information collection method for the wireless network device according to claim 9, wherein
after the wireless network device receives, from the master node, a notification of completion of storage of the information stored in the storage device into the master node or a storage connected to the master node, the wireless network device deletes the information on the subject device stored in the storage device.

11. The information collection method for the wireless network device according to claim 10, wherein
when one or more other wireless network devices are connected to the path to the master node,
the wireless network device detects a communication failure on the path to the master node, and transmits the information stored in the storage device to the other wireless network device confirmed to have no problem on the path to the path to the master node.

12. The information collection method for the wireless network device according to claim 11, wherein
after the wireless network device receives, from the other wireless network device confirmed to have no problem on the path, a notification of completion of storage of the information stored in the storage device into a storage device included in the other wireless network device, the wireless network device deletes the information on the subject device stored in the storage device.

13. The information collection method for the wireless network device according to claim 12, wherein
when recovery of the communication failure on the path to the master node is detected, the other wireless network device transmits the information stored in the storage device of the another wireless network device to the path to the master node.

14. The information collection method for the wireless network device according to claim 9, wherein
when there are two or more paths to the master node, the wireless network device selects a path based on a distance to the master node and a storage capacity of the other wireless network device existing in the path to the master node, and transmits the information stored in the storage device to the selected path to the master node.

15. The information collection method for the wireless network device according to claim 9, wherein
a network management system that manages the wireless network device and the master node
accesses the master node to collect information on the wireless network device stored in the master node or stored in a storage connected to the master node.
